(19) United States
(12) Patent Application Publication
(10) Pub. No.: US 2006/0038929 A1
(43) Pub. Date: Feb. 23, 2006

(54) Tunable spectral imaging filter configured for UV spectral ranges

(76) Inventor: Chenhui Wang, Stow, OH (US)

Correspondence Address: DUANE MORRIS LLP;IP DEPARTMENT, 30 SOUTH 17TH STREET, PHILADELPHIA, PA, 19103-4196, US

(21) Appl. No.: 10/920,533

(22) Filed: Aug. 18, 2004

(51) Int. Cl. G02F 1/1335

(52) U.S. Cl. 349/18

(57) ABSTRACT

A wavelength bandpass filter for chemical imaging and similar uses is configured to minimize absorption in ultraviolet wavelengths and arranged in a Solc, Lyot or similar arrangement of stacked controllable birefringent cells. A number of tunable liquid crystal cells are placed successively in a stack along an optical path, each of the cells having an electrically tunable birefringent element, wherein the cells are dimensioned and arranged at respective angular orientations for passing a tuned bandpass wavelength. A polarizer is arranged at least at an output end for controlling a polarization orientation of light. The liquid crystal cells each comprise at least one supporting plate, an alignment layer and birefringent layer, and wherein the liquid crystal cells are at least 90% transmissive over a UV wavelength tuning range between 280 and 400 ηm or larger.

### BACKGROUND OF THE INVENTION

1. Field of the Invention

The invention relates to a tunable birefringent optical filter, especially for spectral imaging applications, using multiple stacked electrically tunable liquid crystal birefringent cells arranged together and with polarizers, for selective transmission at tuned wavelengths in the ultraviolet region.

An electrically controlled birefringent liquid crystal element with a cyclohexyl based liquid crystal molecule structure renders the element substantially transparent at operational ultraviolet wavelengths, e.g., 280 to 400 ηm. The element is employed as a wavelength bandpass optical filter element in a stacked multiple element liquid crystal tunable filter configuration including one or more polarizers. The associated mounting, substrate plate, any included fixed retarder, the alignment layer, index matched glue, electrical contact and associated physical structures are also transmissive at ultraviolet, rendering the filter useful for certain types of chemical and biological imaging.

2. Prior Art

Wavelength filters for optical imaging applications were developed for spectral analysis of astronomical emissions, such as studying the emission lines in the spectrum of the sun. In basic spectral analysis, it is conventional to think of using a prism or diffraction grating to spread a beam of light from a broad band source into a band of successive rainbow colors, selecting a particular wavelength, for example as a line from the band directed onto a slot.

For imaging applications, it may be desirable to select for particular wavelengths, and also spatially to distinguish light from each point or pixel in a two dimensional array such as the focused image of an illuminated specimen or scene. In an imaging system for analyzing chemical or biological samples, images can be recorded through a spectral filter successively tuned to different wavelengths, so as to collect a full spectrum or at least a set of different selected wavelengths, for each pixel in an image at each wavelength selected. This technique is useful for analysis of chemical and biological samples.

There are various possible applications of the technique and particular parameters that are of interest for one purpose or another in the resulting data. Among other aspects, the data can be useful to identify contrast in the image at particular wavelengths. The data may be processed by automated pattern detection algorithms to detect certain biological features such as cell types. In some chemical imaging procedures, such as Raman imaging, a very narrow wavelength bandpass may be desirable. A combination of two or more wavelengths may be pertinent in assessing contrast. For different such techniques, it may be desirable at times to focus the image on discrete pixel positions defined by photodetector elements, whereas at other times it may be desirable to obtain a diffuse reflection for averaging or other purposes. There are various wavelengths of interest. There are also various techniques involving broadband versus coherent laser illumination, focused or diffuse imaging, wavelength selection using different filter elements that may be simultaneously tuned and other aspects.

In ultraviolet absorption imaging, it may be desirable to illuminate a sample in the ultraviolet in a reflective or transmissive mode, e.g., at wavelengths shorter than 400ηm, and to distinguish pixels and/or patterns in an image based on the extent of ultraviolet absorption. Ultraviolet absorption characteristics and especially particular absorption spectra, are useful for discerning the presence of particular chemical compounds.

There is a potential problem in attempting to image at UV wavelengths, however. The optical elements that are used for imaging, and importantly the elements that permit wavelength bandpass selection, are less transmissive to light at shorter wavelengths than light at longer wavelengths (i.e., more opaque and less transparent) .

Selection for wavelengths, i.e., passing certain wavelengths or bands while blocking others, can use the polarization characteristics of light from the sample as the parameter by which particular wavelengths are discriminated. A wavelength bandpass filter can also use constructive/destructive phase cancellation or interference. One technique for wavelength bandpass filtering is to employ polarization characteristics of light from the sample to discriminate for particular wavelengths. The polarization state of a light beam can be altered by passing the beam through a birefringent optical element. Birefringence is a quality of certain crystals that have different optical indices for light that is polarized or aligned parallel to one of two orthogonal axes of the crystal versus light that is polarized or aligned perpendicular to that axis. The optical index determines the speed of light propagation through the crystal. If a light beam has orthogonal polarization components that are in phase with one another and aligned to the fast and slow axes of a birefringent crystal, then the light aligned to the slow axis lags the light aligned to the fast axis in passing through the crystal. The phase shift in the polarization components that emerge after traversing the crystal amounts to a reorientation of the polarization alignment of the light beam.

Such angular displacement of polarization alignment is a function of the wavelength of the light as well as a function of the thickness and birefringence of the crystal. A given difference in propagation speed, due to birefringence, amounts over time to a given difference in distance along the propagation axis. However, a given distance amounts to a larger phase angle at a shorter wavelength than the same distance at a longer wavelength. Due to this phenomenon, the extent of rotational realignment of the polarization state of light passing through a birefringent crystal is a function of wavelength because the same extent of birefringence and crystal thickness causes different polarization realignment for different wavelengths. By placing a first polarizer at the input to the crystal to select light of a given polarization alignment (such as a polarizer at 45 degrees to the crystal axes so as to couple equally into both the fast and slow crystal axes), and a second polarizer at the output from the crystal, one can selectively pass a particular wavelength or wavelengths of light.

This general technique is used in stacked configurations in which elements are stacked one after another, each element further discriminating the light emerging from the previous element. Using a large number of stacked elements, a narrow wavelength pass band may be achieved, and with a smaller number, the pass band may be broader.

The respective crystal alignments, crystal thicknesses and polarizer placement and orientation are important to cause the successive stages of a stacked filter to pass the required wavelengths and to reject other wavelengths. If the stacked elements are tuned to different wavelengths, then the light will be blocked. According to certain known stacked birefringent filter configurations, different schemes are used to coordinate the thickness (and birefringence) of the crystals, their relative alignments and the use of corresponding polarizers. Some known birefringent filters that use one or both of polarization realignment and filtering or phase interference for wavelength selection and rejection, include the Lyot, Solc and Evans filter configurations. Hybrids of these configurations are possible as well. A resonant interference filter that can employ a birefringent element in an cavity between reflectors is the Fabry-Perot etalon.

A Lyot filter, for example, has a succession of birefringent crystals with integer multiple thicknesses (d, 2d, 4d, 8d, etc.) and a polarizer between each stage. The multiple polarizers used in a Lyot filter tend to reduce the transmission ratio of the stacked filter element as a whole. However, a Lyot filter configuration can be used if there is sufficient input signal strength and provided the optical transmissiveness of the elements of the filter is high. Generally, for stacked filter arrangements including Lyot filters and other configurations, it has not been possible to operate known wavelength bandpass filter stacks in the ultraviolet because the conventional elements used for tunable birefringence, namely liquid crystal elements, generally are absorptive in the ultraviolet band, e.g., 280 to 400ηm, where UV imaging might be useful for distinguishing the absorption spectra of element and compounds in a sample.

A Solc filter configuration does not uses polarizers between each pair of birefringent elements in the filter stack, and instead uses a series of birefringent elements that together realign the bandpass wavelength from the alignment of a polarizer at the input of the stack to the alignment of a polarizer at the output of the stack. A Solc filter can be of the “fan” or “folded” type. Each type generally has an input polarizer and an output polarizer that define a relative angle between them (for example parallel or at 90 degrees), and a stack of abutting crystals of equal thickness (without interleaved polarizers) aligned at orientations that tend to share among the stacked elements the angular span between of the polarizers, namely by distributing the necessary polarization realignment for a specific wavelength incrementally among the cells. For a Solc fan or folded filter, the relative angle is calculated by 2φ, φ=180/(4N), N is the number of liquid crystal elements. Thus, for ten stages in a folded filter, the director orientations of the stacked birefringent elements are each at an angle φ=±4.5 degrees, or at 9 degrees relative to the orientation of the previous element.

A liquid crystal is useful as the birefringent element in the filter configurations described, particularly because the extent of birefringence of the crystal can be varied by varying the voltage applied to the liquid crystal. Varying the voltage applied to a liquid crystal over a range in which the birefringence varies with voltage allows an adjustment of the optical index on one axis while not changing the optical index on the other axis. The adjustment varies the differential phase delay of the orthogonal polarization components through the crystal. This is equivalent to adjusting the thickness along the optical propagation path, of a crystal of fixed birefringence. The liquid crystal amounts to a tunably variable phase retarder and provides a way to adjust the extent of rotation of polarization alignment as a function of wavelength.

In a stacked element configuration, by providing the necessary succession of progressively aligned birefringent elements and polarizers, the stacked configuration can be tuned. Thus for a Solc configuration, the tunable liquid crystal elements are provided with equal effective thicknesses and are/or are operated in coordination to achieve that effect. By electrically altering the birefringence of the elements, their effective optical thickness is adjusted and a bandpass wavelength is selectively tuned. This effect may rely only on the liquid crystal elements as the birefringences in the stack, or the liquid crystals may be arranged with accompanying fixed retarders to add birefringence in a greater or lesser amount to that of the fixed retarders.

Liquid crystals comprise certain chemical compounds that exhibit one or more liquid crystalline phases in which the molecules of the compounds are movably aligned. The material is birefringent when the molecules are aligned and the extent of alignment is adjustable, for example, by applying a control voltage. The particular cell arrangement can be, for example, an ECB cell, a π-cell, VA cell, double-stacked cell, etc. All these arrangements are usefully applied as tunable retarders in a wavelength filter.

Liquid crystals may be characterized by certain differences in chemical composition, but the liquid crystal molecules have some common features in their chemical and physical properties that render them subject to alignment. Thermotropic liquid crystals (those that have liquid crystal properties at certain phases and/or temperatures) include disc shaped (discotics) and elongated (rod-shaped) molecules. The discotics are flat disc-like configurations consisting of a core of adjacent aromatic rings. This allows for two dimensional columnar ordering. Rod-shaped molecules have an elongated, anisotropic geometry which allows for preferential alignment along one spatial direction.

Elongated or rod-shaped liquid crystal molecules need to conform to a line of elongation, namely to have a certain rigidity and linearity to the molecule's constituents. That is, in order for a molecule to have the variable anisotropic characteristics of a liquid crystal, which concern movably variable alignment with other molecules, the molecule must be rigid to an extent as well as elongated,

A standard rod-shaped low molar mass (LMM) liquid crystal composition, such as 5CB, is represented in the following diagram:

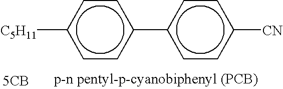

The necessary rigidity and elongation are provided by the interconnection of two rigid cyclic units. The interconnecting group should cause the resulting compound to have a linear planar conformation. Linking units containing multiple bonds such as —(CH═N)—, —N═N—, —(CH═CH)n-, —CH═N—N═CH—, etc. are used because they restrict freedom of rotation. These groups can conjugate with phenylene rings, enhancing anisotropic polarizability. This increases the molecular length and maintains the rigidity of the molecule.

It is possible to employ liquid crystal elements in a stacked wavelength bandpass filter configuration, using equal or related voltages to control the birefringence and effective optical thickness of multiple cells in a coordinated way, and thereby to tune the filter for wavelength.

Theoretically, known configurations for the liquid crystal tunable filter (LCTF), such as the Solc, Evans and Lyot configurations (and other various forms and hybrids) should be adaptable to different tuning bands from which a particular bandpass wavelength can be selected. It may be conceivable to arrange birefringent cell thicknesses, birefringence values, control voltage ranges and the like to provide a tuning range in the visible spectrum or outside of the visible spectrum, e.g., in the ultraviolet. However, conventional liquid crystal cell compositions for stacked cell configurations are not transparent at ultraviolet wavelengths, e.g., 280 to 400ηm. As a result, they are not practical as ultraviolet (UV) LCTFs. It is necessary for the constituents of a liquid crystal molecule generally to provide elongation and structural rigidity aspects needed for controllable birefringence. What is needed, among other challenges, is to provide a controllable birefringence composition that is not absorptive at UV wavelengths.

The liquid crystal birefringence composition is one of several elements that physically and operationally support an electrically tunable birefringence cell in wavelength filter application. One or more polarizers are needed in addition to the cells. Each cell element needs to be physically supported at a predetermined thickness spacing, normally between two spaced substrates such as glass plates that are supported independently by spacers defining the thickness of the flowably viscous liquid crystal composition. An electrical terminal must be arranged across the two inwardly facing surfaces of the glass to vary the electric potential applied to the liquid crystal during tuning. Usually, conductive coatings of indium tin oxide are used for electrical coupling. A molecule alignment layer needs to be arranged on the inward facing sides of such coatings.

The multiple cells also need to be mounted. Insofar as there are multiple plates abutted in a stack (e.g., assuming back-to-back plates of adjacent cells as opposed to shared plates between adjacent cells), the plates need to be glued together. What is needed is a structure that has all these aspects but is still transparent to the wavelength in which the filter is operatively tunable.

In order to be useful in a high performance filter such as a Solc, Evans split-element, Lyot, Fabry-Perot or other configuration or hybrid that is tunably operable in the ultraviolet, such as 280 to 400ηm, the liquid crystal cell should be highly transparent at these UV wavelengths. These filter configurations comprise stacks of plural successive LCTF cells as well as polarizers. Assuming a random alignment, a polarizer immediately rejects 50% of the available light energy if the input light is not polarized or is circular polarized. Although polarizers in successive cells are generally arranged to reject a smaller portion, each polarizer rejects some light regardless of wavelength.

Any light rejection by successive stacked cells is cumulative and detracts from the tuned light signal level that can be obtained through the filter. Selecting for a bandpass wavelength inherently reduces the amplitude of the light signal substantially from the broadband light that might be available from a sample. In tuning for a wavelength at which a tunable birefringence retarder cell is even 90 or 95% transmissive at the tuned wavelength, but wherein there could be ten or twenty or more elements stacked, the available signal level becomes impractically low. What is needed is to provide a filter that comprises component materials, including but not limited to the liquid crystal composition, that are highly transparent down into the ultraviolet wavelengths of interest, while at the same time having properties that are suitable in other respects for a practical tunable spectral imaging filter configured for UV spectral ranges.

### SUMMARY OF THE INVENTION

According to one aspect, the present invention provides an ultraviolet range wavelength tunable liquid crystal tunable filter that contains a stack of successively arranged tunable liquid crystal elements but is sufficiently transparent at wavelengths in an ultraviolet range as to be useful and effective as an UV LCTF.

According to another aspect, a birefringent liquid crystal material having elongated rod component molecules is provided with a rigid portion that is based on a cyclohexylene rather than a phenylene structure, thereby providing rigidity and elongation but being substantially transparent up to a limiting short wavelength in the ultraviolet.

According to a further aspect, the structural components that support, align, electrically connect and adhesively adhered liquid crystal cells in a stack are each composed, selected and configured with one another to maintain and enhance UV transparency.

According to still another aspect, a filter element that is substantially transparent in the ultraviolet region is arranged in a stacked configuration and operated in a UV wavelength range, such as 280 to 400ηm, preferably in Solc tunable arrangement using a minimum number of polarizers.

Additional objects and aspects of the invention will become apparent from the following discussion of examples.

### BRIEF DESCRIPTION OF THE DRAWINGS

A number of additional objects and aspects are apparent from the appended description and the associated illustrations of preferred embodiments, wherein:

FIG. 1 is a schematic perspective view showing a stacked filter arrangement according to the invention, containing liquid crystal cells

FIG. 2 is a schematic perspective view showing an electrically controlled birefringence (ECB) liquid crystal cell.

### DETAILED DESCRIPTION

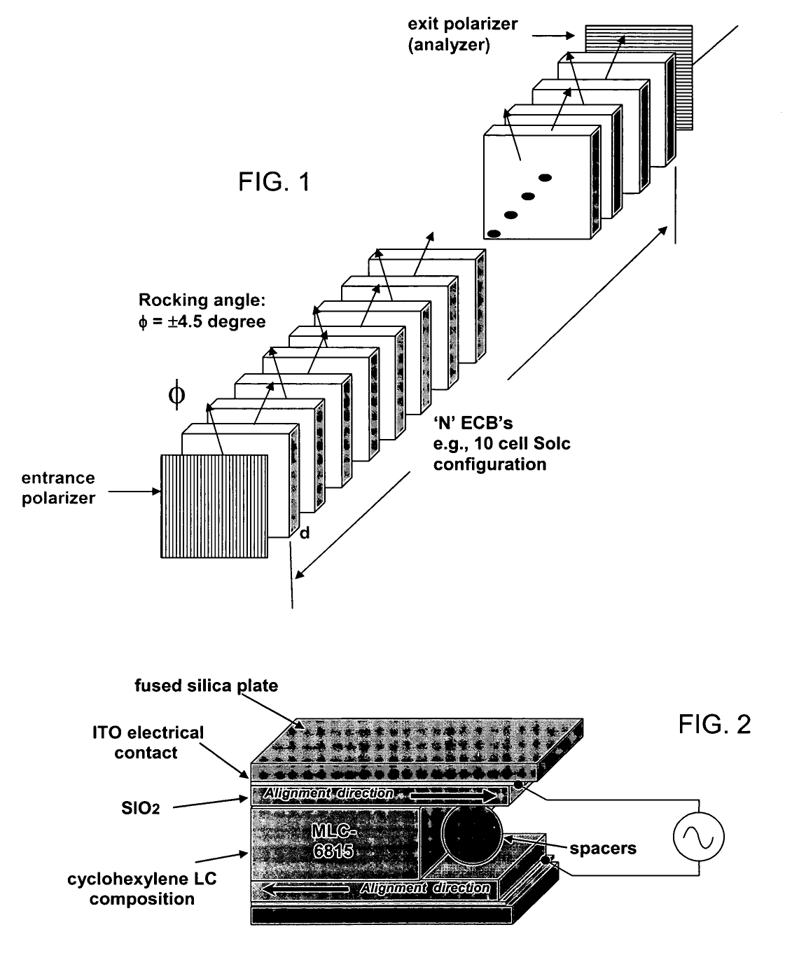

Referring to FIG. 1, the UV LCTFs (ultraviolet liquid crystal tunable filters) of the present invention, are shown, for example in a Solc stacked configuration. In this configuration, variable retardance cells of equal thickness (or effective thickness) are stacked between input and output polarizers. The retardance cells comprise tunable birefringent liquid crystal cells that are stacked and mounted along an optical propagation path together.

The depicted Solc configuration is intended as a nonlimiting example of a tunable UV filter configuration having two or more, and preferably a substantial number, of stacked cells that each contains a liquid crystal element. The invention is also applicable, for example, to other multiple cell stacked configurations such as Lyot, Evans split-element and hybrid configurations. The invention is also applicable to other operational types such as Fabry-Perot etalons containing tunable birefringence cells.

In imaging applications requiring narrow bandwidths, the multiple cell filter as shown can have, for example, twenty to forty or more cells or stages, each contributing a phase retardation enabling discrimination for precisely a narrow band wavelength that emerges with a polarization state aligned to the exit polarizer or analyzer. In UV absorption imaging, it is typical to use a somewhat broader bandpass, for example as obtained using, for example, approximately ten cells in a similar stack configuration.

In FIG. 1, the respective cells are labeled as ECB cells. Pi-cell, tilted vertical aligned (VA) cells, double stacked cells and other similar liquid crystal elements can be used as the variable retarders. These cells each have the structural components shown in FIG. 2, and employ the compositions explained hereinafter, to provide high transparency at the UV wavelengths of interest.

As shown in FIG. 2, an exemplary liquid crystal cell comprises a liquid crystal layer between two substrates or plates of glass or fused silica. The liquid crystal layer is maintained in a space between the plates by spacers. The alignment of the liquid crystal molecules is obtained by two alignment layers facing inwardly. Two conductive coating layers, for example of Indium Tin Oxide are used to make the electrical connections. FIG. 1 shows the arrangement of several cells with polarizers.

Each of these parts is discusses separately herein, and according to an inventive aspect, each of the parts is selected, configured and arranged to produce a stacked filter arrangement that is practical and effective in an ultraviolet tuning range suitable or UV absorption and other chemical imaging uses. Each component of the liquid crystal cell and of the stacked filter as a whole, comprises light transmissive materials that have acceptable transparency in the UV spectral region of interest and together with the other elements contribute to an overall stacked filter arrangement in the UV band.

The stacked filter comprises one or more polarizers. At the input side, a polarizer is aligned to provide a predetermined relative orientation of the input light to the initial liquid crystal cell. At the output or analyzer side, after polarization realignment, the bandpass wavelength emerges with a polarization alignment parallel to the analyzer. The light from the analyzer can be applied to one or more photodetectors that senses light amplitude to define pixel values in encoding an image or a diffuse reflection from a sample (not shown) in an otherwise-known manner. However according to the invention, this operation is facilitated to selectively tuned wavelengths in the ultraviolet.

Sheet dichroic polarizers are sometimes used in liquid crystal display applications, but typically have poor transmission in UV spectral region. Linear, polarizers for use in UV LCTFs of the present invention have acceptable transparency in the UV spectral region of interest, and can linearly polarize the UV light.

The inventive filter arrangement can comprise a Spectro-Physics Ultraviolet Linear Dichroic Polarizer, containing a fused silica plate coated with dichroic coating. According to one embodiment, one or more polarizers are specified for operation in a wavelength range in the span of 230-770μm. For Solc type UV filters, two linear polarizers (entrance and exit) are used, each having high UV transparency to maintain high optical transmittance of the filter at the operational wavelength. In other filter types, polarizers can be placed between successive liquid crystal cells. These embodiments likewise can comprise Spectro-Physics Ultraviolet Linear Dichroic Polarizers in a range of 230-770ηm. In another embodiment, the polarizer can comprise a crystal polarizer, such as a Glan Taylor crystal Polarizer, operable over 220 to 2500ηm. According to the invention, the lower wavelength extreme is of interest.

In addition, in a preferred arrangement, the entrance and exit polarizers are coated with a broad band antireflective coating (BBAR) on the surface, to reduce reflections.

The liquid crystal elements shown as stacked blocks in FIG. 1, are schematically shown for their component parts in FIG. 2, although not to scale. These parts include mechanical mounting arrangements, including substrate plates and spacers between them, the alignment layer for its chemical or molecular effect of establishing a starting molecule alignment, and the electrical arrangements providing electrically conductive layers by which a controlling voltage is applied. Last but not least, the cells each include a liquid crystal layer.

Liquid crystals are a group of organic molecules that have an ability to align their molecular structures to one another with relatively little external energy. Although the molecules could be admixed with other molecules, to form a liquid crystalline (nematic) phase, the organic molecule generally has a rigid core and a flexible tail connected to the core. An example is molecule 5CB shown below. The rigid core typically contains conjugated aromatic molecules, such as benzene groups that are bound together and to the tail. Typically, the conjugated aromatic molecule contains a polar functional end group, e.g. CN, COOR, Br, etc.:

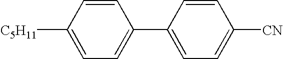

It is known that aromatic molecules and other rigid molecules containing conjugated double/triple bonds have Pi type bonds with loosely bound electrons. These electrons can be easily excited into higher energy states by absorbing UV light energy. Such an UV excitation/absorption reduces the UV light passing thru the material and even more importantly can result in chemical transformations and/or reactions of the molecule ( i.e., referred to as photo-chemistry). Such chemical reactions can cause bond breaking and the destruction of the organic molecules, resulting not only in absorption of UV light, but also progressive chemical degradation. It is also known that when polar functional groups located on the aromatic molecule contain Pi type electrons, the molecule can even more readily absorb UV light.

The nature of the molecule and its UV excitations, i.e., its optical properties, dictate their usefulness for use in UV optical devices and for UV optical applications. Many UV optical devices eschew organics, including organic liquid crystals, and utilize non-organic compounds/materials where possible to achieve their ends.

According to an inventive aspect, by properly changing the liquid crystal rigid core structure (such as changing the benzene rings to aliphatic cyclohexyl structures, preferably in a trans-trans configuration), the present invention shifts the absorption peak of the molecule to a much higher UV energy spectral region.

Examples of cyclohexyl based liquid crystals are described in U.S. Pat. No. 5,178,790. These cyclic, aliphatic liquid crystals do not contain conjugated carbon-carbon double or triple bonds, and therefore can be transparent in regions of the UV spectrum. In one embodiment, a 1,4 substituted cyclohexyl compound has a trans configuration. In another embodiment, the resultant cyclohexyl compound includes an ester functional group. In another embodiment, the cyclohexyl compound comprises a mainly trans-trans bicyclohexyl structure. In yet another embodiment, specially designed cyclohexyl liquid crystal mixtures MLC-6815 and ZLI-1695 from Merck are almost UV-transparent between 250 nanometers to 450 nanometers. Other cyclic aliphatic ring structures can be used to form the rigid core of liquid crystals. For example, U.S. Pat. No. 5,405,550 describes liquid crystals containing 1,1,1-Propellane structures. Cyclic, aliphatic, UV transparent liquid crystals have utility in UV tunable filters of the present invention.

The extent of birefringence of these cyclic, aliphatic, UV transparent liquid crystal materials according to the invention (namely the specific difference in optical index between the fast and slow axes) is typically not as great as the birefringence of aromatic based liquid crystals, due in part to the difference in electron density of the molecular structure. This difference is taken into account when designing liquid crystal tunable filters for a UV spectral range. For example, in order to achieve a particular phase delay, a relatively thicker tunable liquid crystal layer or perhaps an additional fixed retarder is employed at the each stage in addition to the tunable element, as necessary to compensate for limited phase retardation from the birefringence of the liquid crystal material. In this way, the device is applicable as well to Solc configurations with equally sized and often relatively thin retarder cells, or to Evans split-element or Lyot configurations that may have cells that are relatively thick.

A spacer is provided mechanically to maintain the thickness of the zone between the alignment layers, occupied by the deformable liquid crystal material. The spacer is shown in FIG. 2 as a sphere but could be a different shape such as a cylinder or bar or other structural shape. The spacer can be a polymer or silica glass, of a type that is produced in large numbers with relatively uniform size. In one embodiment, the spacer is made of a polymer or silica glass molecular structure that does not contain any loosely bound electrons that can absorb UV light energy. Such particles have acceptable transparency in the desired UV spectral region.

The spacers can be admixed into the liquid crystal material to provide a minimum thickness to which the liquid crystal can be compressed. Alternatively or additionally, the spacer materials may be distributed around the periphery of the liquid crystal material between the plates of the cell (inside the glue edge), instead of being distributed throughout the liquid crystal material. The ratio of volumes of the spacer material to the liquid crystal material is low enough to minimize the effect on light propagating through the liquid crystal material.

The spacers are such as to keep the cell gap a uniform mechanical thickness. It will be appreciated, however, that control of the birefringence of the liquid crystal provides a differential phase delay that is akin to adjusting the thickness by electrical control means.

The alignment layer that faces the liquid crystal material functions to maintain a preferential alignment for liquid crystal molecules that contact the alignment layer. Due to the tendency of the elongated and rigid molecules of the liquid crystal to align with one another, this produces sufficient anisotropy and controllable birefringence to achieve the desired phase retardance effect.

Typically, polyimide materials are used as alignment layers in liquid crystal displays (LCD), which represent a substantial segment of liquid crystal applications. One particular material known as PI2555 from DuPont is widely used. These polyimide materials have an organic molecular structure that contains conjugated double bonds, including aromatic benzene rings. As described above, organic structures of this type contain loosely bound electrons that can be easily excited into higher energy states by absorbing UV light energy. As a result, polyimide alignment materials are not UV transparent.

Polyimide materials can be employed as the alignment layer in the filters of the present invention, provided their thickness is reduced considerably from conventional thicknesses. Alternatively, aliphatic alignment materials not containing conjugated double or triple bonds are advantageously used. In addition, known contact alignment techniques such as brushing or rubbing can be employed to provide directional alignment that is sufficient according to the invention. This can be due to forming the surface in an alignment layer, stretching molecules in the layer or the like.

In one embodiment, an alignment layer is provided comprising inorganic material that does not absorb UV light. The alignment layer can comprise a non-contact, obliquely vapor deposited layer of SiOx, YF₃ or MgF₂. These inorganic alignment layers are optically transparent in a desired UV spectral region. In one preferred embodiment the alignment layer is obliquely sputtered SiO₂.

Ion bombardment techniques are also known to provide alignment layers. An ion bombardment in a prescribed trajectory can break sufficient bonds and rearrange atoms on the surface of an alignment layer to provide alignment that is sufficient to align liquid crystal molecules that rest adjacent to the surface and the next adjacent layers on those molecules tend to continue and perhaps regularize the alignment due to the tendency of the elongated molecules to rest parallel and alongside one another. In one embodiment the alignment layer comprises ion-beam aligned inorganic material, for example including materials such as SiO₂, Al₂O₃ and InTiO₂, et. al., and/or as described in Nature, Vol. 411, P. 56-59, (2001).

The conductive coating layer used to couple a control voltage to the liquid crystal preferably comprises Indium Tin Oxide (ITO). This material is conventionally used as a transparent conductive coating and is apt for the UV LCTF of the present invention. ITO is used as a transparent conductive coating for liquid crystal displays and to control the optical properties of the devices. ITO films are highly transparent in the UV and visible wavelength range. They also have high electrical conductivity.

In one embodiment, the ITO conductive coating layer is used as an alignment layer. Brushing or rubbing techniques may be employed to produce a directional shaping effect on the ITO coating layer that is sufficient to align the liquid crystal molecules so as to achieve the desired anisotropy.

The substrates that carry the foregoing elements are glass or fused silica materials that are transparent in the UV region of interest.

Typical substrates in the liquid crystal display industry, are similar to the substrates in visible spectrum liquid crystal tunable filters and comprise glass that is transparent at visible wavelengths. An example substrate material is Corning 1737F glass. Corning 1737F glass substrate is a low alkali content, high temperature optical glass with its strain point at 666° C. (1231° F.). The thermal expansion coefficient is low (21×10⁻⁷/F). Although its optical properties are good in the visible region, the substrate has poor transmission characteristics in the UV region (especially 250-340ηm). This glass material has an oxide structure with loosely bound electrons which can be easily excited into higher energy states by absorbing UV light energy. Such an UV excitation/absorption reduces the UV light passing thru the material and is not preferred for all the reasons mentioned above.

Substrates for use in a UV LCTFs of the present invention are made of compositions that have tighter bound electrons that do not readily absorb UV light in the desired region of the UV spectrum. Examples of substrates having acceptable UV transparency, preferred according to the invention include fused silica: Corning 7940-0x; Suprasil 1 and 2; and Dynasil 110x. One preferred substrate comprises fused silica from Almaz Optics, Inc. which has excellent UV transparency. These materials are available, for example, from BES Optics, Inc., W. Warwick, R.I. (http://www.besoptics.com/html/body_fused_silica_quartz.html).

Another consideration according to the invention is the UV transparency and optical characteristics of the remaining mounting arrangements, including the adhesive used to adhere the respective plates of back-to-back cells. In a preferred embodiment, an adhesive/glue used in according to the invention is transparent in the 300-400ηm region. As described, the organic molecular structure of the adhesive may not contain any conjugated double or triple bonds, or aromatic rings after the adhesive is fully cured.

Additionally, the UV transparent adhesive has a low coefficient of thermal expansion, preferably to at least approximately match that of the plates that the adhesive affixes. The adhesive also has an optical index similar to or equal to the index of the plates uses as the substrates.

A variety of cured adhesive compositions meet these requirements. In one embodiment, the UV transparent adhesive comprises an aliphatic, curable, epoxy adhesive. In another embodiment the curable epoxy adhesive comprises 301-2 epoxy, or 3401-2FL epoxy from Epoxy Technology Inc. which are essentially UV transparent above 280ηm.

Optical index matching is used where possible to reduce light loss at the interface between different materials. Index matched materials include at least the plates, the glue or adhesive fluid, the index match coating, IM-ITO substrate (such as fused silica, which has an index matching stack (IM) coating between the substrate and the ITO (some time called IMITO)) are preferred. Also, entrance and exit polarizers are coated with a broad band antireflective coating (BBAR) on top in order to reduce the reflection. The final light loss can be reduced dramatically.

The operational range of the UV LCTF of the invention preferably extends at least to 280ηm on the low end, and a nominal UV range can be defined as 280-400ηm. It should be appreciated that this range is preferred and it is possible to push the limits on the low side, e.g., to 250ηm. In a preferred embodiment, the elements of the invention are at least 90% transmissive over a range of 280-400ηm but are useful perhaps with some loss of light level to 250ηm, and also are useful at even higher transparency than 90 to 95%, up into the visual spectrum, i.e., 400 to 500ηm or more. Thus a practical range of 250 to 400ηm or more, and dependably at 280 or 300 to 400ηm, is achieved by the invention.

In a preferred exemplary arrangement, at least a subset of the liquid crystal cells comprise a substrate plate selected from the group consisting of glass, fused silica plate, Corning 7940-0x; Suprasil 1 and 2; and Dynasil 110x. Preferably, all the cells are similarly structured in the stack, with two spaced plates, the plates of adjacent or abutting back-to-back cells being adhered, preferably with index matched and non-reflective adhesives and coatings, respectively.

As stated, a preferred tunable birefringent element at least for one or more of the cells and preferably all of the cells, has a molecular structure with at least one cyclic aliphatic ring, preferably at least two cyclic aliphatic rings, and more preferably wherein the at least two cyclic aliphatic rings comprise at least two cyclohexyl rings. The cyclic aliphatic rings can comprise two 1,1,1-Propellane rings, a 1, 1′bicyclohexyl, a trans-trans-cyclohenxyl molecular structure, etc. and can have at least one carbon atom in common. Furthermore, the birefringent material can comprises a mixture of such materials or a mixture of one or more of the materials with other compounds.

The preferred molecular alignment layer is applied to facing surfaces of the plates of the cells, and has a surface that is one of brushed, rubbed, ion bombarded, sputtered and obliquely vapor deposited, e.g., of SiOx and more specifically SiO₂. Alternatively or in combination, the alignment layer can comprise obliquely vapor deposited MgF₂.

The invention having been disclosed in connection with the foregoing preferred arrangements, variations will now be apparent, and should be considered encompassed within the scope and spirit of the claimed invention.

What is claimed is:

1. A wavelength bandpass filter comprising:
a plurality of tunable liquid crystal cells placed successively in a stack along an optical path, each of the cells having an electrically tunable birefringent element, wherein the cells are dimensioned and arranged at respective angular orientations for passing a tuned bandpass wavelength;
at least one polarizer arranged for controlling a polarization orientation of light at one of an input side and an output side of the stack;
wherein the liquid crystal cells each comprise at least one supporting plate, alignment layer and birefringent layer, and wherein the liquid crystal cells are substantially transmissive over a UV wavelength tuning range.

2. The filter of claim 1, wherein the liquid crystal cells are at least 90% transmissive over a UV wavelength tuning range from about 280-400ηm.

3. The filter of claim 1, wherein the stack comprises one of a Solc, Lyot and Evans split-element filter configuration.

4. The filter of claim 1, wherein the stack comprises a Solc configuration of adjacent liquid crystal cells and polarizers placed on both ends of the stack.

5. The filter of claim 2, wherein at least a subset of the liquid crystal cells each comprises a substrate plate containing fused silica plate that is substantially transparent in the UV wavelength tuning range.

6. The filter of claim 2, wherein at least a subset of the liquid crystal cells comprise a substrate plate selected from the group consisting of glass, fused silica plate, Corning 7940-0x; Suprasil 1 and 2; and Dynasil 110x.

7. The filter of claim 1, wherein the stack comprises a folded Solc configuration having at least 2 filter elements.

8. The filter of claim 1, wherein the stack comprises a folded Solc configuration having at least ten filter elements.

9. The filter of claim 1, wherein the stack comprises a folded Solc configuration having at least 32 filter elements.

10. The filter of claim 1, wherein the tunable birefringent element of at least one of the cells includes a liquid crystal material having a molecular structure comprising at least one cyclic aliphatic ring.

11. The filter of claim 10, wherein the at least one cyclic aliphatic ring comprises a 1,4 substituted cyclohexyl ring having a trans configuration.

12. The filter of claim 10, wherein said molecular structure comprises at least two cyclic aliphatic rings.

13. The filter of claim 12, wherein the at least two cyclic aliphatic rings comprise at least two cyclohexyl rings.

14. The filter of claim 13, wherein the at least two cyclohexyl rings comprise a 1, 1′bicyclohexyl molecular structure.

15. The filter of claim 14, wherein the 1,1′bicyclohexyl molecular structure comprises a trans, trans configuration.

16. The filter of claim 12, wherein the at least two cyclic aliphatic rings have at least one carbon atom in common.

17. The filter of claim 16, wherein the at least two cyclic aliphatic rings comprise a 1,1,1-Propellane ring structure.

18. The filter of claim 1, wherein the tunable birefringent element of at least one of the cells comprises a mixture of cyclic, aliphatic liquid crystal materials.

19. The filter of claim 6, wherein each of the liquid crystal cells comprises a pair of spaced plates comprising one of glass and fused silica, said plates being substantially transparent over the UV wavelength tuning range.

20. The filter of claim 10, further comprising a conductive layer applied to the plates of said cells, wherein the conductive layer is substantially transparent over the wavelength tuning range.

21. The filter of claim 10, further comprising a molecular alignment layer applied to facing surfaces of the plates of said cells, and wherein the alignment layer comprises a surface that is one of brushed, rubbed, ion bombarded, sputtered and obliquely vapor deposited.

22. The filter of claim 10, further comprising a molecular alignment layer applied to facing surfaces of successive pairs of plates for each of said cells, and wherein the alignment layer comprises an obliquely vapor deposited SiOx.

23. The filter of claim 22, wherein the obliquely sputtered surface comprises SiO₂.

24. The filter of claim 10, further comprising a molecular alignment layer applied to facing surfaces of the each successive pair of plates, and wherein the alignment layer comprises obliquely vapor deposited MgF₂.

25. The filter of claim 10, further comprising at least one of a spacer between the spaced plates in a pair and an adhesive affixing abutting plates of adjacent pairs.

26. The filter of claim 25, comprising a spacer that is substantially transparent over the wavelength tuning range.

27. The filter of claim 1, further comprising an adhesive compound that is substantially transparent over the wavelength tuning range.

28. The filter of claim 1, further comprising an adhesive compound affixing abutting plates of back-to-back ones of the cells, wherein the adhesive compound is substantially transparent over the wavelength tuning range.

29. The filter of claim 1, wherein at least two adjacent ones of the supporting plate, the alignment layer, an electrical contact, the birefringent layer, the polarizer, and an adhesive compound between said adjacent ones, are optical-index matched.

30. The filter of claim 1, further comprising a broad band antireflective coating (BBAR) on at least one said polarizer forming one of an input and an output surface of the filter.
